(19) United States
(12) Patent Application Publication
(10) Pub. No.: US 2026/0241967 A1
(43) Pub. Date: Aug. 20, 2026

(54) CONTROL SYSTEM AND METHOD FOR A RAIL-TRACK SYSTEM

(71) Applicant: Magway Limited, Manchester (GB)

(72) Inventors: Rupert Cruise, Manchester (GB); Mark Lazarides, Manchester (GB); Aanchal Mittal, Manchester (GB); Onat Taskin, Manchester (GB); Timoteo Badalotti, Manchester (GB); William Frank-Gemmill, Manchester (GB)

(21) Appl. No.: 19/160,702

(22) PCT Filed: Feb. 28, 2024
(86) PCT No.: PCT/EP2024/055161

§ 371 Date: Aug. 28, 2025

(30) Foreign Application Priority Data
Feb. 28, 2023 (JP) 2023-030294

(51) Int. Cl. B61L 27/10; B61L 27/53

(52) U.S. Cl. CPC B61L 27/10; B61L 27/53

(57) ABSTRACT

A control system for controlling the movement of a carriage within a rail-track system is provided. The system comprises: a central controller configured to schedule a trajectory of the carriage; and a plurality of decentralised nodes, each associated with a respective portion of the rail-track system, and each configured to control the movement of the carriage within said associated portion of the rail-track system according to said trajectory. A transport system and method are also provided.

### FIELD OF THE INVENTION

This application relates to a control system and method for controlling the movement of a carriage within a rail-track system.

### BACKGROUND

Traditional delivery methods are expensive, polluting, and poorly connected between central depots and their required delivery point, often requiring several different transportation methods. Heavy goods vehicles are usually diesel powered and produce significant greenhouse emissions as well as tyre and brake particulates. Most trains used for goods delivery are also diesel powered and thus produce large amounts of polluting emissions. Even if trains, and in potential future cases heavy good vehicles, are electrically powered they nevertheless require heavy infrastructure and frequent maintenance. As such, they incur significant operating costs and require large capital expenditure. Exacerbating the above problems is the fact that these methods of transport are also very inefficient, with heavy goods vehicles and trains consuming large quantities of fuel and energy. Heavy goods vehicles require extensive road networks which are susceptible to cause delays due to traffic, weather, and prolonged periods of maintenance and renovation; all of which are common. Furthermore, heavy goods vehicles also create a large amount of noise pollution.

For traditional rail delivery similar issues occur, while rail networks are also unsuitable for delivering goods to localised depots. Large depot to depot transport will be called “trunk route” delivery or transport from here on. “Branch route” delivery or transport is therefore required to deliver goods from trunk depots to localised depots. This trunk and branch approach means that these traditional delivery methods are only suitable for delivering goods on trunk routes and at scale, requiring a substantial amount of goods to be transported in batches. Additionally, transition between “trunk routes” and “branch routes” in the traditional approach frequently requires warehouses, which are large and expensive to build and maintain.

Nor can this problem be solved by using light goods vehicles instead of heavy goods vehicles. Even when electrically powered, such light goods vehicles produce pollution due to tyre and brake particulates. Furthermore, the number of light goods vehicles required to replace heavy goods vehicles means that overall efficiency is reduced and operating costs are increased. Consequently, light goods vehicles are only suitable for branch routes and do not, therefore, provide a seamless transport solution suitable for both trunk and branch routes.

The emphasis on trunk and branch routing arises from the fact that traditional rail infrastructure is large so must be routed around populated areas. Thus, traditional delivery systems are designed to go from large, centralised depots and sorting centres to regional depots and sorting centres, which still require further transport to the final endpoint.

There are also reliability and safety issues in traditional delivery methods arising from the highly decentralised control of the delivery vehicles involved. For example, if a crash occurs, or a train car derails, then it takes a considerable amount of time for that message to be passed “down the line” to other cars or trains, if at all, and there is a reliance on other vehicles in the system correctly responding to the crash. Furthermore, due to the trunk routing, and the lack of fast and detailed information sharing, rerouting of vehicles around a crash is often impossible or, if not, typically leads to significant reductions in the throughput of the system.

In addition to the problems discussed above, one of the largest issues with traditional delivery methods is their lack of scalability. Traditional delivery methods struggle with scalability for several reasons, some of which have been mentioned above. The most important factors are the trunk routing, high cost, and complexity of expanding the infrastructure. This is especially problematic when high density delivery networks would be preferable and where future expansion or rerouting are likely and frequent.

The problems discussed above are also present in the delivery systems typically used within the mining industry. When excavating materials from a mine it is necessary to remove those materials, which includes waste materials such as rock and earth as well as the commodities being mined, from the mine. It is frequently also necessary to supply the mine with backfill to fill cavities. In order to achieve this aim, mines typically use rail systems which, although operating on a smaller scale, operate along similar principles to those discussed above.

Another solution used in the mining industry to remove materials is to use conveyor belt systems. While these are relatively straightforward to set up, they are typically limited in their ability to move materials from one point to another. Firstly, all of the material on a conveyor belt moves in the same direction at the same speed, meaning that there is only a limited degree to which different types of material may be conveyed on the same conveyor belt. Secondly, conveyor belt systems are usually designed around the same trunk and branch approach discussed above.

There is therefore a need for a solution to the problems posed above in the form of high density, scalable, and efficient goods delivery system allowing for a scalable system for growing and changeable networks.

### SUMMARY OF INVENTION

According to a first aspect of the invention, a control system for controlling the movement of a carriage within a rail-track system is provided. The system comprises: a central controller configured to schedule a trajectory of the carriage; and a plurality of decentralised nodes, each associated with a respective portion of the rail-track system, and each configured to control the movement of the carriage within said associated portion of the rail-track system according to said trajectory.

By making use of a central controller and decentralised nodes, a control system is provided which is highly scalable and modular. This is because, as additional portions of the rail-track system (in effect “modules” of track) are added, corresponding decentralised nodes can also be added to control much of their functionality. Thus, the additional complexity and processing required due to the addition of a track portion is delt with by the corresponding decentralised controller, rather than the centralised controller. The ease with which this system can therefore deal with expansion and change makes it ideal for situations where high density and highly changeable networks are required. This contrasts with a highly centralised system in which the expansion of the rail-track system is limited by the processing capacity of the central control system and the bandwidth and latency within the communication system connecting this central control system to the different portions of the rail-track system.

This system also contrasts with highly decentralised systems in which each vehicle is controlled either by a human operator or by an on-board control system, which are decentralised controllers with little exchange of information between one another. The current invention, by controlling the movement of the carriage externally using communicating decentralised nodes, can precisely control the headway, which is the distance between this carriage and other carriages traveling through the rail-track system. This both ensures that a safe headway is kept between carriages but also allows two carriages to travel more closely together, thereby improving the efficiency of the system.

The trajectory of the carriage scheduled by the central controller is used to define the high-level parameters of the movement of the carriage through the rail-track system, and preferably comprises one or more of: a route through the rail-track system; and a departure time from a start point in the rail-track system. The departure time may take into account a required or preferred arrival time for the carriage at certain points in the rail-track system, such as a final endpoint. In this way, the central controller can ensure goods carried by the carriage are delivered to the correct location and at the correct time, with the decentralised nodes controlling the movement of carriages according to this trajectory.

In order to improve the coordination between the decentralised nodes, each of the plurality of decentralised nodes is preferably configured to communicate with at least one other of the plurality of decentralised nodes, wherein said at least one other of the plurality of decentralised nodes advantageously comprises at least one adjacent decentralised node, which is to say that, for each portion of track, the corresponding decentralised node is configured to communicate with at least one other decentralised node associated with an adjacent portion of track.

In this way, when controlling the movement of the carriage within their respective portions of track, each of the plurality of decentralised nodes can take account of the movement of the carriage within the portions of track associated with other decentralised nodes. One way this manifests itself is in allowing a decentralised node to take account of the speed at which the carriage will be traveling when entering said node's associated portion of the rail-track system. Another way is that rail-track restrictions in subsequent portions of the rail-track system can be accounted for when controlling the movement of the carriage. Simply put, the handing over of a carriage from one decentralised node to another can be made more seamless.

As explained above, the decentralised nodes control the movement of the carriage according to the trajectory scheduled by the central control. Each of the plurality of decentralised nodes may also be configured to control the movement of the carriage according to one or more carriage restrictions within the associated portion of the rail-track system, wherein said one or more carriage restrictions typically comprise one or more of: a maximum speed; a maximum acceleration; and a maximum deceleration. These carriage restrictions may be determined by the central controller, for example if there is a need to reduce the speed of the carriage within one portion of the rail-track system so as to account for a bottleneck in another portion of the rail-track system, or these carriage restrictions may be predetermined. For example, the curvature of the track within a portion of the rail-track system may place physical limits on the maximum safe speed and/or acceleration of the carriage within that portion. As used herein, “acceleration” is to be interpreted as encompassing deceleration of a carriage, which is to say that a maximum acceleration defines both the maximum rate at which the speed of a carriage may be increased and the rate at which the speed of a carriage may be decreased. Furthermore, as used herein, “acceleration” and “speed” are defined along the track portion which the carriage is traveling on. Therefore, acceleration is used herein to define the rate of change of a carriage's speed along the track portion.

The central controller may also be configured to schedule the trajectory of the carriage according to one or more of: throughput requirements; maintenance requirements; rail-track restrictions; and carriage prioritisation. Just as the specific control of the carriage by the decentralised nodes may be based on limitations and restrictions of the associated portions of track, the trajectory of the carriage may likewise be scheduled based on limitations and restrictions of the rail-track system. These restrictions may affect the entire rail-track system, such as scheduled downtime for maintenance, or may be restrictions on a specific portion or portions of the rail-track system which the affect the route scheduled by the central controller for the carriage.

The control system is preferably configured such that multiple carriages are controlled at once, some of which may be travelling within the same portion of the rail-track system. As such, the central controller is preferably configured to schedule one or more trajectories of one or more further carriages and the plurality of decentralised nodes are each configured to control the movement of said one or more further carriages within its associated portion of the rail-track system. In such embodiments, the control of each of these one or more further carriages will be as described above in relation to a single carriage.

As noted above, one benefit of the present invention is that, by controlling the movement of the carriage externally using the decentralised nodes, the headway between two carriages traveling through the rail-track system may be precisely controlled. This allows the headway between carriages to be reduced, thereby improving both the aerodynamic efficiency and maximum throughput capacity of the system. Aerodynamic efficiency is improved when carriages travel more closely as drag is reduced for the carriages following behind other carriages. Maximum throughput capacity is improved when the space between carriages is reduced as there will be more carriages within a given portion of the rail-track system at any one point in time.

The plurality of decentralised nodes are preferably each configured to detect a fault within the respective portion of the rail-track system and to report said fault to the central controller, and the central controller is advantageously configured to schedule a new trajectory of the carriage according to the reported fault. In this way, the decentralised nodes may promptly detect and notify the central control system of any errors within the rail-track system. For example, if a linear motor, as used in some of the embodiments discussed below, were no longer working correctly, or if one decentralised node were to stop correctly communicating with another decentralised node, then this can be reported to the central control system. This would allow for new trajectories to be created for the carriage or carriages if required, as well as for maintenance and checks to be taken as quickly as possible. Therefore, a safe and reliable control system is created.

The rail-track system preferably further comprises one or more switches, turntables, or substitution rails for connecting a plurality of rail-track sections. One or more of the decentralised nodes are configured to control one or more of said switches, turntables, or substitution rails, although one or more of the switches, turntables, or substitution rails could also be controlled by another entity, such as the central controller. Switches facilitate changes in carriage trajectory as well as connections between different sections of the rail-track system. Switches may take the form of a switch which allows a carriage to pass through either a left-hand or right-hand side of a “Y junction”. The decentralised nodes are used to control the switches to allow for all the benefits of the partially decentralised control system as described previously.

According to a second aspect of the invention, a transport system is provided which comprises a control system according to the first aspect of the invention and a rail-track system. By making use of the control system of the first aspect of the invention, the transport system of the second aspect of the invention is highly modular and therefore scalable.

The transport system is particularly suited to use with a rail-track system comprising a plurality of linear motors, in which case each of the plurality of decentralised nodes would preferably be configured to control the movement of the carriage by controlling one or more of the plurality of linear motors. In a conventional rail system a carriage is typically either provided with its own propulsion system or is linked to another carriage with its own propulsion system to form a train, with this propulsion usually taking the form of an engine or an electric motor. It is extremely difficult to control motors which are contained within carriages which move within a transport system in a centralised and reliable way, especially for a rail-track system consisting of a complex network of rail-tracks. However, if the motors are integral to the rail-track system, rather than within the carriages, centralised control is greatly simplified and made more reliable. Furthermore, having the motors in carriages adds weight which must be propelled through the rail-track system, which reduces the efficiency of the system. Carriages provided with their own propulsion systems must also be made larger to accommodate said propulsion systems, which in turn leads to the overall system being larger to allow for such carriages and their infrastructure. These problems are overcome by integrating linear motors into the rail-track system, as this allows the use of carriages without their own propulsion systems. Therefore, the invention as described in this application provides a transport system and method which can be smaller in size than conventional transport systems, which in turn means that the system can be more easily scaled to include new endpoints. While the central controller and decentralised nodes are suitable for controlling the loading and unloading of carriages, in some embodiments it is advantageous for these operations to be handled by a separate logistics system. In such embodiments, the central controller is preferably configured to communicate with a logistics system which is configured to implement the loading and/or unloading of the carriage and/or the one or more further carriages.

In this way, the control and transport systems of the present invention allow seamless integration of the transport system with external systems to reduce time taken and cost of loading and unloading of delivery goods. An example of preparation may be opening or unlocking lid or compartment provided in the carriage, or imposing a speed restriction as the carriage enters a loading or unloading area of the rail-track system.

According to a third aspect of the invention, a method of controlling the movement of a carriage within a rail-track system comprising a central controller and a plurality of decentralised nodes is provided, wherein each decentralised node is associated with a respective portion of the rail-track system and the method comprises: scheduling, by the central controller, a trajectory of the carriage; and controlling, by one or more of the decentralised nodes, the movement of the carriage within the corresponding one or more portions of the rail-track system.

This method provides the same benefits discussed above in relation to the first and second aspects of the invention.

### BRIEF DESCRIPTION OF DRAWINGS

Embodiments of the invention will now be described with reference to the figures, in which:

FIG. 1 shows a schematic diagram of a transport system used to transport goods in the prior art;

FIG. 2 shows a schematic diagram of a transport system provided according to embodiments of the present invention;

FIG. 3 shows an example of a track and a carriage for use within a transport system provided according to embodiments of the present invention;

FIG. 4 shows an example of a control system for controlling the movement of a carriage within a rail-track system provided according to embodiments of the present invention;

FIG. 5 shows another example of a control system for controlling the movement of a carriage within a rail-track system provided according to embodiments of the present invention;

FIG. 6 shows a schematic diagram of a rail-track system according to embodiments of the present invention;

FIG. 7 shows an example of the restrictions imposed on a carriage traveling through the portion of the rail-track system shown in FIG. 6; and

FIG. 8 shows another example of the restrictions imposed on a carriage traveling through the portion of the rail-track system shown in FIG. 6.

### DETAILED DESCRIPTION

The present disclosure relates to a transport system comprising carriages and a rail-track system, configured to allow for the transportation of goods within a depot to client endpoint integrated system. The terms “goods” and “loads” are used interchangeably to refer to materials and items transported by vehicles.

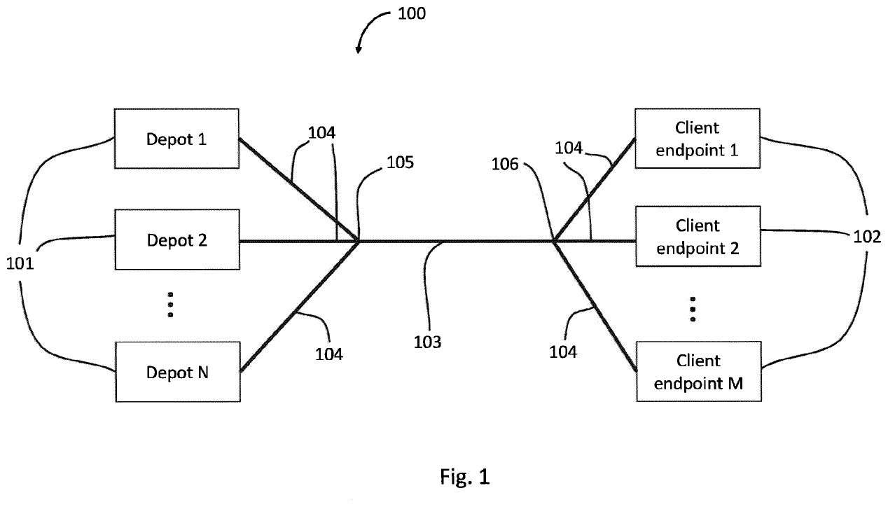

Transport systems are typically designed based on a trunk and branch approach, with an example of a prior art transport system 100 shown in FIG. 1. In transport system 100, goods depots 101 are connected with client endpoints 102 via track sections 103 and 104, with track section 103 forming a trunk section 103 and track sections 104 forming branch sections 104. In the example shown in FIG. 1, the branch sections 104 connect to trunk section 103 at two connection points 105 and 106, which typically take the form of centralised depots.

While in the schematic shown in FIG. 1 trunk section 103 is of similar dimensions to branch sections 104, in practice trunk section 103 will cover a far greater distance than branch sections 104. Goods received from depots 101 are transported along branch sections 104 to the nearest connection point 105 with trunk section 103, which in transport system 100 is shared between N depots 101. Since the branch sections 104 are only designed to carry goods from a single depot, the goods are typically transported along each branch using light goods vehicles, although other similar light goods transport systems may also be used.

Goods received at connection point 105 are transferred between the vehicles used to transport goods along branch sections 104 and trunk section 103. Often this involves moving those goods to a warehouse for temporary storage, before being loaded onto the vehicles used for transporting the goods along trunk section 103 to connection point 106. These vehicles are typically heavy goods vehicles or freight trains.

Upon reaching the connection point 106 with branch sections 104, goods are then frequently transferred to temporary storage before being loaded into the light goods vehicles used to deliver goods to client endpoints 102.

While transport system 100 has proven to be more efficient and cost effective than using light goods vehicles to connect depots 101 directly to client endpoints 102, it nevertheless has a number of downsides.

One of these is that, as noted above, the vehicles used on trunk route 103 are typically heavy goods vehicles or freight trains. These vehicles require heavy infrastructure and frequent maintenance, leading to significant operating costs and large capital expenditure. They are also usually diesel powered and therefore produce large amounts of polluting emissions.

A related problem is that the capital expenditure and high operating costs typically associated with trunk routes in the prior art limit the degree to which these transport systems may be scaled to serve additional depots and client endpoints outside of the current trunk infrastructure. This is especially true if new trunk routes need to be created or significantly altered.

Another downside is that the branch routes 104 are often provided by light goods vehicles. While these vehicles are increasingly battery powered and therefore produce fewer emissions than their diesel-and petrol-powered equivalents, they nevertheless contribute towards pollution from, among other sources, tyre and brake particulates and also contribute towards the problem of traffic congestion.

Furthermore, even if steps are taken to mitigate the problems associated with the transportation of goods along the trunk route 103 and the branch routes 104, the necessity to transfer goods between these routes adds complexity to the transportation of goods. Not only can goods be lost when being transferred between routes at connection points 105 and 106, but the transfer process leads to delays and typically requires large warehouses and sortation centres to be constructed to store goods received at the connection points (i.e. from trunk route transportation) while they await onward transport (i.e. using branch route transportation). Thus, for the aforementioned reasons, as well as for others such as noise and safety concerns, such trunk-to-branch transport system needs to be routed around populated areas, often placing connection points far away from the client endpoints. Therefore, it is readily apparent that the solution provided by the prior art is inefficient.

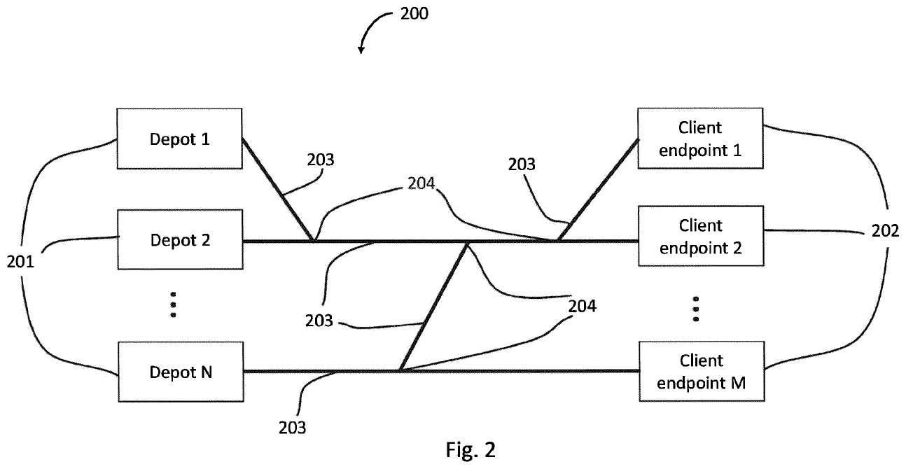

In contrast to the prior art transport system 100 depicted in FIG. 1, the transport system 200 shown in FIG. 2 allows for end-to-end delivery of goods between depots 201 and client endpoints 202 in a scalable and efficient manner.

In this system, routes 203 are provided between depots 201 and client endpoints 202. These routes 203 are not divided into trunk and branch routes but rather are directly connected at connection points 204 such that a vehicle traveling through system 200 may switch directly between routes 203 at connection points 204. In this way, a vehicle leaving one of depots 201 may travel without interruption along routes 203 to one of client endpoints 202.

This system removes the need for sortation centres and warehouses between trunk and branch routes, as is often required by the prior art, as no transition between trunk and branch route exists. Therefore, in regard to this system, adding or reducing topological complexity has no bearing on the complexity of the centralised/decentralised control system. While FIG. 1 depicts a traditional transport system, a similar topology could be implemented in a system as described herein, where the distinction between trunk and branch routes would disappear with the present invention.

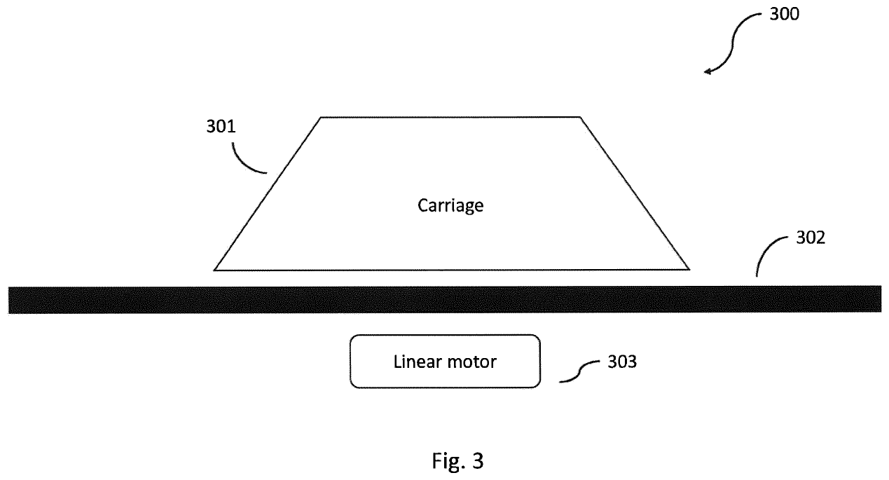

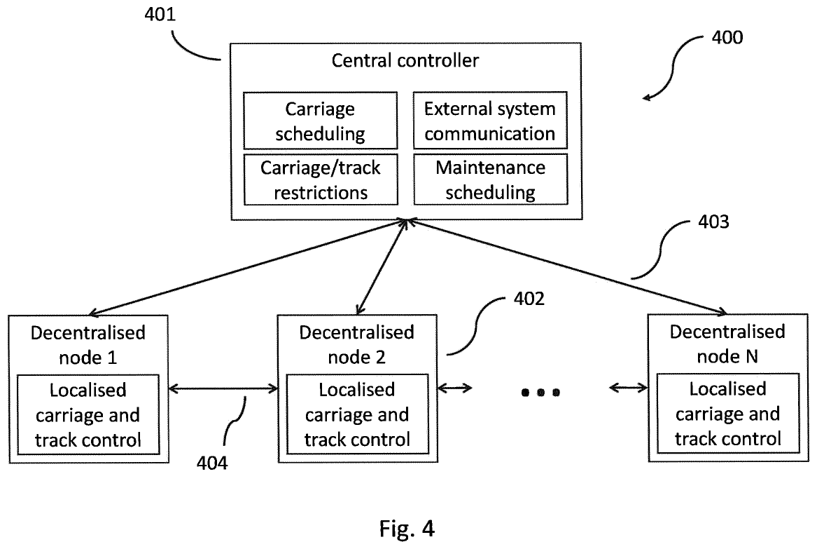

One of the ways this alternative approach is made possible in embodiments of the present invention is the control system used to control the movement of vehicles in the system 200. This will be discussed below with reference to FIGS. 4 to 7. Another is that, in some embodiments of the present invention, the vehicle takes the form of a carriage and the routes 203 together form a rail-track system comprising a plurality of linear motors, as illustrated in FIG. 3.

FIG. 3 illustrates a schematic diagram of a portion 300 of a rail-track system which may be used in embodiments of the invention to provide a transport system such as transport system 200. In such embodiments, a carriage 301 is provided which comprises a permanent magnet (not illustrated), for example on the carriage underside, and preferably proximal to the track 302. Although not shown, the carriage 301 used in these embodiments runs on wheels along track 302. However, the present invention is not limited to wheels and may use different mechanisms, such as sliders.

In a conventional rail-track the drive for a carriage is either provided by a propulsion system in the carriage itself or by linking the carriage to a locomotive which is provided with the propulsion system. “Locomotive”, as used herein, is defined in the usual sense, which is a carriage or “train car” which is self-propelled and used to pull or push other carriages. A propulsion system in the carriage itself leads to, among other things, increased size and weight of the carriage and of the associated track. Linking the carriage to a locomotive which is provided with a propulsion system further leads to inefficiencies as an entire locomotive is required for the purpose of propulsion alone which, typically, does not carry goods itself. Moreover, fitting a carriage with a propulsion system would generally require increase in size of the same carriage, which effect is undesirable as it leads to a larger cross-sectional area for the overall system. However, by providing a permanent magnet, for example on the underside of the carriage 301, a linear motor 303 may be integrated within track 302 removing the need to provide a propulsion system in the carriage itself or in an associated “locomotive”.

When this rail-track system is used in the embodiment illustrated in FIG. 2, the routes 203 are provided by track 302 and at least one linear motor 303 is provided within each of routes 303. As a carriage 301 travels through the system 200, drive is provided by actuating a linear motor 303 as the carriage 301 passes along the corresponding section of track 302.

In this way, carriages 301 may be used to deliver goods between depots 201 and client endpoints 202 which are significantly more lightweight than the vehicles used in conventional transport systems. In turn, the track 302 can be made sufficiently lightweight to allow a transport system using rail-track system 300 to replace the conventional trunk and branch approach.

It should be noted that the topology of the routes illustrated in FIG. 2 is merely exemplary and other topologies could be provided. For example, a rail-track system such as is shown in FIG. 3 could be implemented in a transport system having a topology similar to that of the transport system 100 shown in FIG. 1 in which carriages 301 travel from depots 101 along routes 104 directly onto a connecting route 103 before leaving route 103 and joining routes 104 to reach client endpoints 102.

As noted above, another way that the alternative transport system 200 is made possible is through the use of a new design of control system. An example of such a control system is shown schematically in FIG. 4.

Control system 400 is a control system for controlling the movement of a carriage within a rail-track system comprising a central controller 401 and a plurality of decentralised nodes 402, with each decentralised node 402 being associated with a respective portion of the rail-track system. This system 400 is based on the principle of directing the high-level aspects of the movement of carriages within the rail-track system, such as the start and end-points of a carriage's trajectory, centrally and decentralising the control of the movement of the carriages. Specifically, the central controller 401 is configured to schedule a trajectory for each carriage within the rail-track system, while the plurality of decentralised nodes 402 control the movement of the carriages within their respective portions of the rail-track system according to these trajectories.

Along with the start-and endpoints of loads to be transported through the system, throughput and maintenance requirements feed into the central controller 401 and these form the basis of the high-level scheduling of the trajectories of the carriages. This ensures that loads are transported between their respective start-and endpoints and that a predefined total throughput is maintained, while also ensuring that the track and carriages are kept in working order. Maintenance requirements may be the cleaning of the track by a track-cleaning machine, the inspection of carriages for wear after a certain distance travelled, or any other necessary routine.

In embodiments of the invention provided according to FIG. 4, the central controller 401 schedules a trajectory for a carriage according to one or more of: throughput requirements; maintenance requirements; and rail-track restrictions; and carriage prioritisation. The central controller 401 then determines the routes available for the carriage taking into account the departure times as well as any errors or malfunctions in the rail-track system, which means that one or more portions of the rail-track system should be avoided. This route and the departure time of the carriage together form the trajectory for the carriage. In this way, the central controller 401 may determine a trajectory so as to maximise the overall efficiency of the rail-track system.

The central controller 401 follows this process for each carriage within the rail-track system to determine a trajectory for each of said carriages. In some instances, the routes available for one carriage will be affected by the trajectories determined for one or more other carriages in the rail-track system. The central controller 401 may, therefore, determine the trajectories of one or more of the carriages based on the determined trajectories of one or more other carriages.

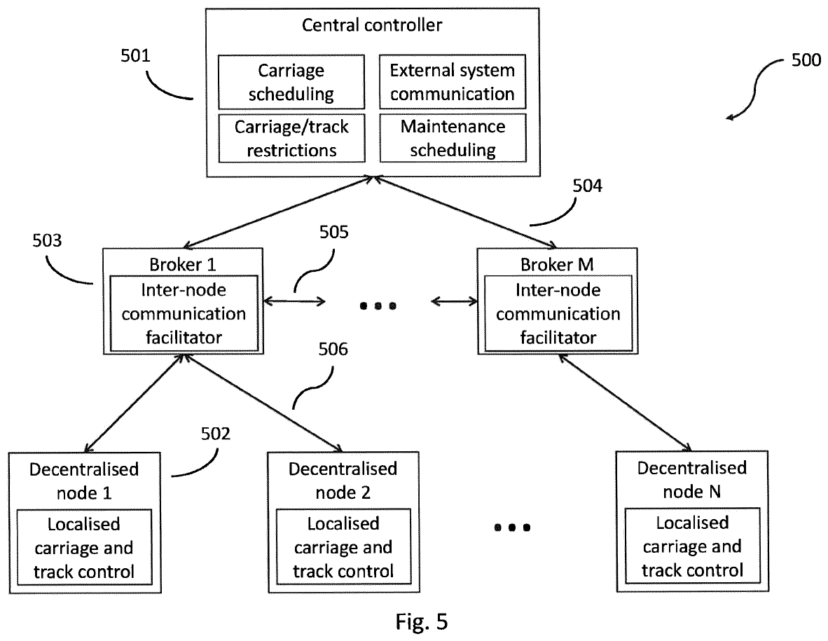

The decentralised nodes 402 receive the trajectories for the carriages scheduled to travel through their respective portions of the rail-track system from the central controller 401, which in the example illustrated in FIG. 4 are communicated directly to the decentralised nodes 402 via communication links 403. Alternatively, the scheduled trajectories may be communicated via one or more intermediaries, as will be described in greater detail below with reference to FIG. 5.

In order to allow the decentralised nodes to coordinate the control of the movement of the carriages, it is advantageous for the decentralised nodes 402 to be communicatively coupled. In the control system 400, this coupling is provided by means of communication links 404 between adjacent decentralised nodes 402. The control system 400 is advantageously used to control the movement of carriages with a rail-track system provided according to the embodiment shown in FIG. 3, with the carriages comprising permanent magnets and linear motors integrated into the track, with each portion of the rail-track system comprising at least one linear motor. Each decentralised node 402 controls the movement of a carriage in such embodiments by actuating one or more linear motors provided within its respective portion of the rail-track system. During this process, other track functions may be controlled by the decentralised nodes. For examples, one or more switches, turntables, or substitution rails may be actuated by the decentralised nodes.

In addition to scheduling the trajectories of the carriages, the central controller 401 is configured to communicate with a logistics system that is configured to implement the loading and unloading of the carriages. In order to allow for loading and unloading of carriages, the central controller 401 will preferably designate portions of the rail-track system as being loading/unloading areas. If the load carried by a carriage is to be loaded or unloaded then that carriage's scheduled trajectory will comprise an indication that the carriage should stop in a loading/unloading area. Once the carriage has stopped in a loading/unloading area, the corresponding decentralised node 402 communicates this to the central controller 401, which in turn communicates with the logistics system. Once the loading or unloading is complete, this is communicated to the central controller 400. If, during the above-mentioned process, a switch, turntable, or substitution rail is required to be actuated, this may be controlled by a decentralised node.

The trajectories scheduled by the central controller 401 and the control of the movement of the carriages by decentralised nodes 402 may also be subject to restrictions on the rail-track system. For example, each section of the rail-track system may be subject to a speed restriction based on, for example, one or more of rail-track capabilities, network design, and long-term reliability considerations. For example, a curved section of track will typically be restricted to lower carriage speeds than a straight section of track to ensure carriages do not derail when traveling around corners. Another reason for a speed restriction is to ensure that carriages may be slowed down to prevent collisions with slower moving or stopped carriages in certain regions of the rail-track system, such as in loading/unloading areas where it is expected that carriages will frequently be stationary.

The rail-track restrictions may also be used by the central controller 401 when scheduling the trajectories of carriages to determine which routes are available for each carriage and to ensure that the scheduled trajectory will allow the carriage to reach its endpoint by its required arrival time.

The decentralised nodes 402 will also control the movement of the carriages according to any rail-track restrictions. For example, a decentralised node 402 will control the movement of carriages within its respective portion of the rail-track system such that they do not exceed any speed restrictions imposed on said portion of the rail-track system.

The central controller 401 may also impose specific restrictions on the carriages themselves. For example, a maximum acceleration may be imposed on a carriage if it is carrying delicate or fragile goods, such as fruits and vegetables, in which case any sudden acceleration or deceleration of the carriage could cause damage. Another example of a carriage restriction includes a speed restriction. This may be based on the load carried by a carriage or by dynamic conditions in the rail-track system. For example, if a fault is detected in the system, then speed restrictions may be dynamically imposed on the carriages by the central controller 401. These speed restrictions may be global or may be applied to a specific portion or to specific portions of the rail-track system.

As noted above, the scheduled trajectories may be communicated via one or more intermediaries. An example of a control system 500 according to some embodiments of the invention in which schedules are communicated via intermediaries will now be described with reference to FIG. 5, in which central controller 501 communicates with decentralised nodes 502 via brokers 503. The trajectories are first communicated to these brokers 503 via communications links 504 and the brokers 503 then transmit each trajectory to the relevant decentralised nodes 502 via communications links 506. While FIG. 5 shows each decentralised node 502 in communication with a single broker 503, a decentralised node 502 may communicate with more than one broker 503. All communications described above may be two-way communications. For example, a decentralised node may explicitly request information from a broker or other entity, and then have that information communicated back to it. This two-way communication is illustrated in FIGS. 4 and 5 by the use of double-headed arrows.

In the example shown in FIG. 5, as well as communicating with the central controller 501 via brokers 503, the decentralised nodes 502 preferably communicate with one other via brokers 503 using communications links 506 when coordinating the control of the movement of the carriages. However, in some embodiments, the decentralised nodes 502 may be in direct communication with one another as illustrated in FIG. 4.

The control system 500 shown in FIG. 5 is otherwise configured to operate in the same manner as the control system 400 of FIG. 4, with the functions performed by the central controller 501 and the decentralised nodes 502 being the same as those performed by the central controller 401 and decentralised nodes 402.

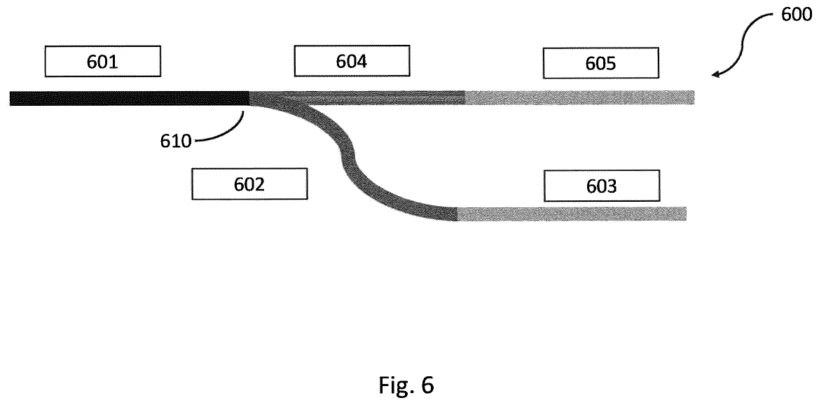

A specific example of the control of a carriage by the decentralised nodes will now be described with reference to FIG. 6. FIG. 6 shows a rail-track system 600 comprising a plurality of track portions 601 to 605 which, in the embodiment of FIG. 6, each correspond to a different decentralised node. As will be appreciated, rail-track systems provided according to embodiments of the present invention may be larger and/or more complex. Equally, the rail-track system 600 could form part of a larger rail-track system provided according to embodiments of the invention.

The central controller may schedule a trajectory for the carriage in which the carriage travels from track portion 601 to track portion 602 and onwards to track portion 603. As the carriage travels through track portion 601 its movement is controlled by the corresponding decentralised node. For example, the decentralised node may actuate a linear motor in track portion 601 to accelerate or decelerate the carriage.

At the junction between track portions 601, 602, and 604, the decentralised node associated with track portion 601 actuates a switch 610 to direct the carriage towards track portion 602 and away from track portion 604. The switch may also be controlled by a different entity, such as another decentralised node. This switch 610 may take the form of a set of points, as used in conventional rail-track systems, but the present invention is not limited to this design of switch. For example, a linear motor could be used to steer the carriage towards track portion 602. The present invention is also not limited to a switch which allows the choice between only two possible carriage trajectories, but instead a singular switch could be used to facilitate the ability to use a plurality of different trajectories. An example of a switch which may facilitate the ability to use a plurality of different trajectories would be a turntable switch.

After the switch, the carriage travels through track portions 602 and 603 and its movement is controlled by the corresponding decentralised nodes.

In order to allow the decentralised nodes associated with each of track portions 601 to 605 to coordinate the control of the movement of the carriage, it is advantageous for each of the decentralised nodes to communicate with the adjacent decentralised nodes, which is to say the decentralised node associated with an adjacent track portion.

As mentioned above, the decentralised nodes may control the movement of the carriages based on rail-track restrictions such as maximum speeds. For example, a track portion which contains a bend may be subject to a maximum speed restriction to ensure the carriages do not derail. Similarly, a track portion directly prior to a switch may have a lower maximum speed restriction than a track portion directly after the switch in order to ensure that, if there is an issue with the switch, the carriage may nonetheless be stopped prior to reaching the switch. These restrictions therefore ensure the carriage moves at a safe speed.

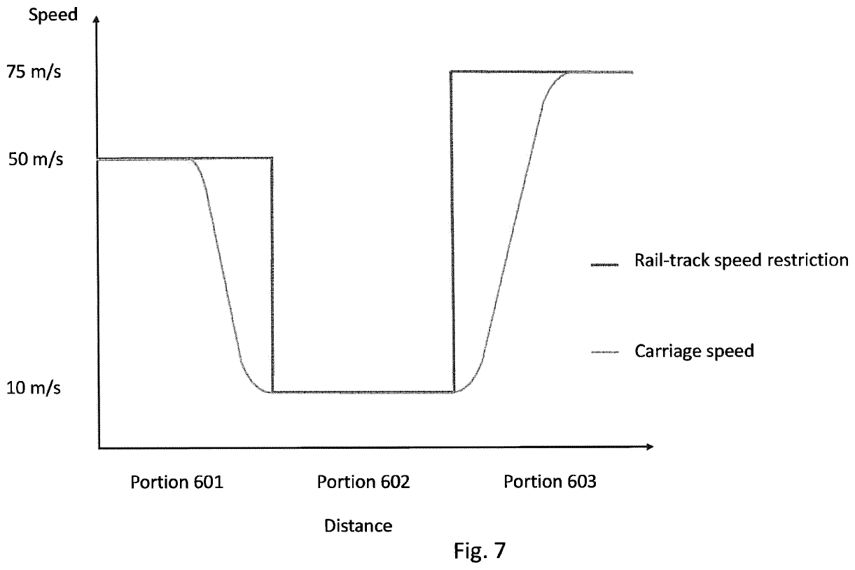

In order to maximise throughput of the rail-track system, it is advantageous for the carriage to move at the maximum possible speed. FIG. 7 shows an exemplary speed-distance graph of a carriage, including track-based restrictions being imposed on the carriage, in relation to the track portions 601 to 603 as depicted in FIG. 6.

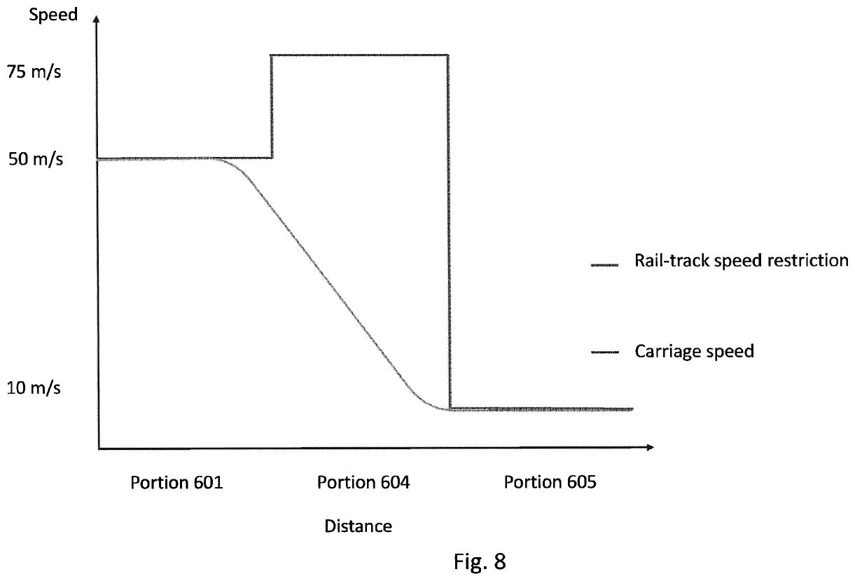

While not explicitly shown in FIG. 7, the carriages also follow carriage restrictions in the form of a maximum allowable acceleration of the carriage. It will be understood that, since FIG. 7 shows a speed-distance graph, a constant acceleration restriction, if depicted on the graph, would be a curve. The changes in the speeds of the carriages shown in FIG. 7, as well as FIG. 8, therefore are merely intended to illustrate carriage speeds which conform to both rail-track speed and carriage acceleration restrictions.

As FIG. 6 depicts, track portion 602 comprises an “S” curve before leading to track portion 603. This track structure leads to a track restriction being placed on it, which, as mentioned previously, is controlled and maintained by a decentralised node. Similarly track portion 601 may have a lower maximum speed than track portion 603 as it is directly before a switch.

Additionally, while the embodiment in FIG. 7 shows how the speed on track portion 601 is gradually decreased to accommodate the maximum speed restriction on track portion 602, it is generally required to accommodate the speed of the carriage according to the speed and acceleration restrictions of a plurality of track portions further along the carriage trajectory.

Track portion 604 may have a higher maximum speed restriction than track portion 601, while track portion 605 may have a lower maximum speed restriction than track portion 601. This may be because track portion 605 requires a reduced speed for safety reasons, for example.

FIG. 8 depicts how a carriage moving between track sections 601, 604, and 605 reduces its speed to conform to speed restrictions of track portions further ahead along its trajectory, while also conforming to acceleration carriage restrictions. The speed of the carriage is reduced while still in portion 601 to ensure sufficient time to slow down before reaching portion 605 so that the carriage does not break the rail-track speed restriction of portion 605. This is because if the reduction in speed started any later, it would not be able to slow the carriage down sufficiently to meet the speed restriction of track portion 605 while also conforming to the carriage acceleration (which in this case is a maximum deceleration) restriction. Therefore, the carriage does not increase its speed when in track portion 604, despite the increase in rail-track speed restriction in track portion 604. This is merely an example to illustrate why it is generally required to accommodate the speed of the carriage according to the speed and acceleration restrictions of a plurality of track portions further along the carriage trajectory.

A carriage traveling through these track sections is accelerated at a rate close to, or at, the maximum rate allowed by the carriage restriction and a non-collision requirement to ensure the carriage travels at the maximum possible speed through the rail-track system 600, thereby maximising throughput of the system. A non-collision requirement is implemented so that carriages with different trajectories and acceleration restrictions do not collide. For example, it can be seen from FIGS. 7 and 8 that, in these examples, the carriage passing from portion 601 to portion 602 begins decelerating earlier than the carriage passing from portion 601 to portion 604. This is because it is advantageous for the carriages to move at the maximum possible speeds, as discussed above. However, if a first carriage whose trajectory leads from portion 601 to portion 604 is traveling closely behind a second carriage whose trajectory leads from portion 601 to portion 602, then said first carriage will decelerate earlier than illustrated in FIG. 8 to ensure the two carriages do not collide.

Therefore, not only is the current position and speed of a carriage typically taken into account when controlling the movement of the carriage, but the restrictions implemented in upcoming portions of the rail-track system are also taken into account, as are the position and speed of other carriages.

It should be noted that in some embodiments it is advantageous for track portions adjacent to a switch, turntable, or substitution rail to be controlled by a single decentralised node. In the example shown in FIG. 6, this would mean that track portions 601, 602, and 604 formed a singled portion of the rail-track system controlled by a corresponding decentralised node.

1. A control system for controlling movement of a carriage within a rail-track system, the system comprising:
a central controller configured to schedule a trajectory of the carriage; and
a plurality of decentralised nodes, each associated with a respective portion of the rail-track system and each configured to control the movement of the carriage within said associated portion of the rail-track system according to said trajectory.

2. The control system according to claim 1, wherein the trajectory of the carriage comprises one or more of: a route through the rail-track system; and
a departure time from a start point in the rail-track system.

3. The control system according to claim 1, wherein each of the plurality of decentralised nodes is configured to communicate with at least one other of the plurality of decentralised nodes so as coordinate the control of the movement of the carriage, and wherein said at least one other of the plurality of decentralised nodes comprises at least one adjacent decentralised node.

4. (canceled)

5. The control system according to claim 1, wherein each of the plurality of decentralised nodes is configured to control the movement of the carriage according to one or more carriage restrictions within the associated portion of the rail-track system, and wherein said one or more carriage restrictions comprise one or more of: a maximum speed; and a maximum acceleration.

6. (canceled)

7. The control system according to claim 5 wherein the central controller is configured to determine at least one of said one or more carriage restrictions.

8. The control system according to claim 1, wherein the central controller is configured to schedule the trajectory of the carriage according to one or more of: throughput requirements; maintenance requirements; rail-track restrictions; and carriage prioritisation.

9. The control system according to an claims 1, wherein the central controller is configured to schedule one or more trajectories of one or more further carriages and the plurality of decentralised nodes are each configured to control the movement of said one or more further carriages within its associated portion of the rail-track system.

10. The control system according to claim 1, wherein the plurality of decentralised nodes are each configured to detect a fault within the respective portion of the rail-track system and to report said fault to the central controller, and wherein the central controller is configured to schedule a new trajectory of the carriage according to the reported fault.

11. (canceled)

12. The control system according to claim 1, wherein the rail-track system further comprises one or more switches, turntables, or substitution rails and wherein one or more of the decentralised nodes is configured to control one or more of said switches, turntables, or substitution rails

13. A transport system comprising:
a control system according to claim 1; and
a rail-track system.

14. The transport system according to claim 13, wherein the rail-track system comprises a plurality of linear motors, wherein each of the plurality of decentralised nodes is configured to control the movement of the carriage by controlling one or more of the plurality of linear motors.

15. (canceled)

16. A transport system according to claim 13, wherein the central controller is configured to communicate with a logistics system which is configured to implement loading and/or unloading of the carriage and/or the one or more further carriages.

17. A method of controlling movement of a carriage within a rail-track system comprising a central controller and a plurality of decentralised nodes, wherein each decentralised node is associated with a respective portion of the rail-track system, the method comprising:
scheduling, by the central controller, a trajectory of the carriage; and
controlling, by one or more of the decentralised nodes, the movement of the carriage within the corresponding one or more portions of the rail-track system.

18. The method according to claim 17, wherein the trajectory of the carriage comprises one or more of: a route through the rail-track system; and a departure time from a start point in the rail-track system.

19. The method according to claim 17, wherein the movement of the carriage is controlled by the one or more decentralised nodes according to one or more carriage restrictions within the associated portion of the rail-track system, wherein said one or more carriage restrictions comprise one or more of: a maximum speed; and a maximum acceleration.

20. (canceled)

21. The method according to claim 19, method-further comprising determining, by the central controller, the one or more carriage restrictions.

22. The method according to claim 17, wherein the trajectory of the carriage is scheduled by the central controller according to one or more of: throughput requirements; maintenance requirements; rail-track restrictions; and-or carriage prioritisation.

23. The method according to claim 17, further comprising:
scheduling, by the central controller, one or more trajectories of one or more further carriages; and
controlling, by one or more of the decentralised nodes, the movement of the one or more further carriages within the corresponding one or more portions of the rail-track system.

24. The method according to claim 17, wherein controlling the movement of the carriage and/or the-one or more further carriages comprises controlling, by one or more of the decentralised nodes, one or more linear motors.

25. The method according to claim 17, wherein the rail-track system comprises one or more switches, turntables, or substitution rails and wherein the method further comprises controlling, by one or more of the decentralised nodes, one or more of said switches, turntables, or substitution rails.
